(19) United States
(12) Patent Application Publication
(10) Pub. No.: US 2026/0003910 A1
(43) Pub. Date: Jan. 1, 2026

(54) INFORMATION DISPLAY METHOD, INFORMATION PROCESSING METHOD, INFORMATION INTERACTION METHOD, AND COMPUTING DEVICE

(71) Applicant: Hangzhou Alibaba International Internet Industry Co., Ltd., Hangzhou (CN)

(72) Inventors: Rong ZHANG, Hangzhou (CN); Denghui LIANG, Hangzhou (CN); Yi DING, Hangzhou (CN)

(21) Appl. No.: 19/320,465

(22) Filed: Sep. 5, 2025

Related U.S. Application Data
(63) Continuation of application No. PCT/CN2024/079148, filed on Feb. 28, 2024.

(30) Foreign Application Priority Data
Mar. 7, 2023 (CN) 202310218648.5

(51) Int. Cl. G06F 16/9032; G06V 10/12; G06V 30/148

(52) U.S. Cl. CPC G06F 16/9032; G06V 10/12; G06V 30/153

(57) ABSTRACT

The embodiments of the present application provide an information display method, an information processing method, an information interaction method, and a computing device. The information display method comprises obtaining an information carrier that bears a plurality of object names, the information carrier being used to identify and obtain at least one object name therefrom; performing a query operation based on the information carrier to determine at least one object corresponding to each of the at least one object name; providing object prompt information in a display interface for each of the at least one object corresponding to each of the at least one object name. The technical solution provided by the embodiments of the present application improves the efficiency of object processing.

### CROSS-REFERENCE TO RELATED APPLICATION

This application is a Continuation Application of International Patent Application No. PCT/CN2024/079148, filed on Feb. 28, 2024, which is based on and claims priority to and benefits of Chinese patent application filed on Mar. 7, 2023, with the application No. 202310218648.5, and entitled “Information Display Method, Information Processing Method, Information Interaction Method, and Computing Device”. The entire content of the aforementioned applications is incorporated herein by reference.

### TECHNICAL FIELD

The embodiments of this application relate to the field of computer application technology, particularly to an information display method, an information processing method, an information interaction method, and a computing device.

### BACKGROUND

In order to improve the service quality and efficiency for service personnel when serving their objects, online systems built using information technology and internet technology are commonly used to store relevant information about different objects. This allows service personnel to easily query information about the objects and perform corresponding operations to provide the required services.

In practical applications, when service personnel query an object, they typically need to manually input the object name. This method is cumbersome and reduces processing efficiency, especially when there are many objects to query. In such cases, the increase in online interactions may also affect the system's performance.

### SUMMARY

Embodiments of this application provide an information display method, an information processing method, an information interaction method, and a computing device, aiming to solve the problem of low object processing efficiency in the prior art.

A first aspect of the embodiments of this application provides an information display method, including:
obtaining an information carrier that bears a plurality of object names, the information carrier being used to identify and obtain at least one object name therefrom;
performing a query operation based on the information carrier to determine at least one object corresponding to each of the at least one object name;
providing object prompt information in a display interface for each of the at least one object corresponding to each of the at least one object name.

Optionally, the method further includes:
providing at least one piece of processing prompt information in the display interface;
in response to a processing operation triggered for any piece of the processing prompt information, determining a corresponding target processing method and determining at least one target object corresponding to the target processing method;
performing a processing operation on the at least one target object according to the target processing method.

Optionally, performing the processing operation on the at least one target object according to the target processing method includes any of the following implementations:
when the target processing method is a follow-up method, requesting to establish a first binding relationship between the at least one target object in an unfollowed-up state and a service personnel, and switching the at least one target object to a followed-up state;
when the target processing method is an attention method, requesting to establish a second binding relationship between the at least one target object in a followed-up state and a service personnel, and outputting notification prompt information when any object with a second binding relationship with the service personnel is in an unfollowed-up state;
when the target processing method is an add method, requesting to determine and store object-related information for the at least one target object in a nonexistent state, and switching the at least one target object to an unfollowed-up state.

Optionally, the information carrier is a target image bearing a plurality of object names, and obtaining the information carrier bearing a plurality of object names includes:
performing image acquisition on a medium containing a plurality of object names to obtain the target image;
alternatively, in response to an image selection operation, obtaining the target image from local storage.

Optionally, performing a query operation based on the information carrier to determine at least one object corresponding to each of the at least one object name includes:
sending a query request including the information carrier to a server, so that the server identifies and obtains at least one object name from the information carrier;
alternatively, performing text recognition on the information carrier, and sending a query request including the recognition results to the server, so that the server filters and obtains at least one object name from the recognition results.

Optionally, providing object prompt information for each of the at least one object corresponding to each of the at least one object name in the display interface includes:
determining an arrangement order of the at least one object corresponding to each of the at least one object name; and, based on the arrangement order of the at least one object name in the information carrier, determining display positions corresponding to each of the at least one object name, and displaying the object prompt information for the at least one object at their corresponding display positions according to the arrangement order of each corresponding at least one object;
alternatively, determining the arrangement order of the at least one object corresponding to each of the at least one object name; and, based on the arrangement order, displaying the object prompt information for a first object corresponding to each of the at least one object name in the display interface, as well as displaying view prompt information corresponding to each of the at least one object name, wherein the method further includes:
in response to a triggering operation for the view prompt information corresponding to any of the object names, displaying the object prompt information for at least one undisplayed object corresponding to the object name, according to the corresponding arrangement order.

Optionally, the execution of the query operation based on the information carrier includes:
sending a query request based on the information carrier to the server, so that the server can determine at least one object that corresponds to the at least one object name;
obtaining the object prompt information for the at least one object corresponding to the at least one object name returned by the server.

Optionally, the method further includes:
in response to an object selection operation, determining the at least one selected candidate object;
the determination of at least one target object corresponding to the target processing method includes:
determining the at least one target object corresponding to the target processing method from the at least one candidate object.

Optionally, the determination of the arrangement order of the at least one object includes:
determining the arrangement order of the at least one object based on the matching degree between the at least one object and its corresponding object name, the object status of the at least one object, and at least one of the object rankings of the at least one object.

Optionally, the method further includes:
displaying the at least one object name on the display interface;
displaying at least one operation prompt information on the display interface for the at least one object name;
in response to a trigger operation for any of the operation prompt information, processing the at least one object name according to the corresponding operation method.

Optionally, the method further includes:
displaying at least one piece of processing prompt information on the display interface corresponding to any object's object prompt information;
in response to a processing operation triggered by any piece of the processing prompt information, determining the corresponding target processing method, and performing the processing operation on the object according to the target processing method.

Optionally, the method further includes:
in response to a view operation for the object prompt information of any object, displaying the object detail page for the object on the display interface.

A second aspect of the embodiments of this application provides an information processing method, including:
determining at least one object name identified and obtained from an information carrier, the information carrier bearing a plurality of object names;
querying at least one object corresponding to each of the at least one object name;
based on the query results, sending object prompt information for each of the at least one object corresponding to each of the at least one object name to a client.

Optionally, the method further includes:
sending at least one piece of processing prompt information to the client;
determining a corresponding target processing method and determining at least one target object corresponding to the target processing method in response to a processing request sent by the client for any piece of the processing prompt information;
performing a processing operation on the at least one target object according to the target processing method.

Optionally, performing the processing operation on the at least one target object according to the target processing method includes any of the following implementations:
when the target processing method is a follow-up method, establishing a first binding relationship between the at least one target object in an unfollowed-up state and a service personnel, and switching the at least one target object to a followed-up state;
when the target processing method is an attention method, establishing a second binding relationship between the at least one target object in a followed-up state and a service personnel, and notifying the service personnel when any object with a second binding relationship to the service personnel is in an unfollowed-up state;
when the target processing method is an add method, storing object-related information for the at least one target object in a nonexistent state, and switching the at least one target object to an unfollowed-up state.

Optionally, querying at least one object corresponding to each of the at least one object name includes:
querying at least one object corresponding to each of the at least one object name, and determining the arrangement order of at least one object corresponding to each of the at least one object name;
and wherein sending the object prompt information for the at least one object to the client includes:
determining display positions corresponding to each of the at least one object name based on the arrangement order of the at least one object name in the information carrier;
sending the display positions of the at least one object name, the object prompt information for each of the at least one object corresponding to each of the at least one object name, and the arrangement order of the at least one object to the client, so that the client displays the object prompt information for each of the at least one object at their respective display positions corresponding to the object names, according to the arrangement order of each corresponding at least one object.

Optionally, querying at least one object corresponding to each of the at least one object name and determining the arrangement order of the at least one object includes:
when the at least one object name includes a plurality of object names, assigning the plurality of object names to a plurality of threads;
using the plurality of threads to perform query operations on the at least one object name assigned to each thread, in order to determine at least one object corresponding to each of the at least one object names and to determine the arrangement order of the at least one object.

Optionally, the determination of the arrangement order of the at least one object includes:
determining the arrangement order of the at least one object based on the matching degree between the at least one object and its corresponding object name, the object status of the at least one object, and at least one of the object rankings of the at least one object.

Optionally, the method further includes:
sending object selection prompt information to the client;
determining the at least one selected candidate object based on the object selection request sent from the client;
the determination of at least one target object corresponding to the target processing method includes:
determining the at least one target object corresponding to the target processing method from the at least one candidate object.

Optionally, querying the at least one object that corresponds to the at least one object name includes:
when the at least one object name includes a plurality of object names, using a plurality of threads to query in parallel the at least one object corresponding to each of the plurality of object names.

Optionally, the determination of the at least one object name obtained through recognition from the information carrier includes:
receiving the information carrier sent by the client, performing text recognition on the information carrier, and selecting at least one object name from the recognition result;
alternatively, obtaining the recognition result sent by the client, and selecting at least one object name from the recognition result; wherein the recognition result is obtained by the client performing text recognition on the information carrier.

Optionally, the recognition result includes a plurality of recognized texts corresponding to the plurality of object names, and selecting at least one object name from the recognition result includes:
filtering out invalid characters and invalid texts from the plurality of recognized texts, and obtaining at least one object name.

Optionally, querying the at least one object that corresponds to the at least one object name includes:
for any given object name, determining at least one keyword contained within the object name;
identifying at least one object that matches the object name based on one or more keywords.

The third aspect of the embodiments of this application provides an information interaction method, including:
detecting a startup operation for the client;
providing a runtime environment for the client to initiate the client, the client being used to obtain an information carrier bearing a plurality of object names, and based on the information carrier, performing a query operation to determine at least one object corresponding to each of at least one object names, and providing object prompt information for each of the at least one object corresponding to each of the at least one object names in a display interface.

The fourth aspect of the embodiments of this application provides an application program, which runs a client to implement the information display method as described in the first aspect above.

The fifth aspect of the embodiments of this application provides a computing device, including a processing component and a storage component; the storage component stores one or more computer instructions; the one or more computer instructions being callable and executable by the processing component to implement the information display method as described in the first aspect above, the information processing method as described in the second aspect above, or the information interaction method as described in the third aspect above.

The sixth aspect of the embodiments of this application provides a computer storage medium, which stores a computer program. When the computer program is executed by a computer, it implements the information display method as described in the first aspect above, the information processing method as described in the second aspect above, or the information interaction method as described in the third aspect above.

The embodiments of this application obtain an information carrier that bears a plurality of object names, and identify and obtain at least one object name from the information carrier. Based on the information carrier, a query operation can be performed to determine at least one object corresponding to each of the at least one object name. This allows providing object prompt information for each of the at least one object corresponding to each of the at least one object name in a display interface of the client. Through the automatic recognition of the information carrier to determine at least one object name, there is no need to manually input object names. In the case of recognizing a plurality of object names, batch object queries can be realized, improving query efficiency, thus enhancing processing efficiency, reducing online interaction, and ensuring system performance.

These and other aspects of the present application will become more readily apparent from the description of the following embodiments.

### BRIEF DESCRIPTION OF THE DRAWINGS

To more clearly illustrate the technical solutions in the embodiments of the present application or in the prior art, the drawings to be used in the description of the embodiments or the prior art will be briefly introduced below. It is obvious that the drawings in the following description are some embodiments of the present application, and for those of ordinary skill in the art, other drawings can be obtained based on these drawings without creative efforts.

FIG. 1 illustrates a schematic structure diagram of an information processing system according to an embodiment of the present application.

FIG. 2 illustrates a flowchart of an information display method according to an embodiment of the present application.

FIGS. 3A to 3C illustrate schematic diagrams of the client interface display in a practical application of an embodiment of the present application.

FIGS. 4A to 4B illustrate schematic diagrams of the client display interface in another practical application of an embodiment of the present application.

FIG. 5 illustrates a schematic diagram of the client display interface in yet another practical application of an embodiment of the present application.

FIG. 6 illustrates a flowchart of an information processing method according to an embodiment of the present application.

FIG. 7 illustrates a schematic diagram of a scenario interaction in a practical application of an embodiment of the present application.

FIG. 8 illustrates a flowchart of an information interaction method according to an embodiment of the present application.

FIG. 9 illustrates a schematic structure diagram of an information display device according to an embodiment of the present application.

FIG. 10 illustrates a schematic structure diagram of an information processing device according to an embodiment of the present application.

FIG. 11 illustrates a schematic structure diagram of a computing device according to an embodiment of the present application

### DETAIL DESCRIPTION OF THE EMBODIMENTS

To make the technical solutions of the present application better understood by those skilled in the art, the technical solutions in the embodiments of the present application will be clearly and completely described below in conjunction with the accompanying drawings in the embodiments of the present application.

In some of the processes described in the specification, claims, and the accompanying drawings of this application, a plurality of operations appear in a specific sequence. However, it should be clearly understood that these operations can be performed in a different order or executed in parallel, and the numbers like 101, 102, etc., are simply used to distinguish different operations; the numbers themselves do not represent any execution order. Additionally, these processes may include more or fewer operations, and these operations can be executed sequentially or in parallel. It should be noted that the terms “first,” “second,” etc., are used to distinguish between different messages, devices, modules, etc., and do not indicate any particular order or imply that the “first” and “second” are of different types.

The technical solutions of this application are applied in scenarios where an online system helps service personnel manage objects. For example, the service personnel can be salespeople, and the object can refer to the clients faced by the salesperson. The online system can refer to a CRM (Customer Relationship Management) system. The service personnel can collect, manage, analyze, and utilize customer information in relation to clients.

In practical applications, service personnel often have the need to query objects. For example, service personnel may need to query clients listed on water tags in office buildings or in offline exhibition client sign-in registers to obtain relevant information and identify potential clients. Currently, when service personnel perform client queries, they typically manually enter customer names from images, documents, etc., one by one into the CRM system to perform queries. Based on the retrieved client information, the subsequent service content is determined. This process is cumbersome, has low processing efficiency, and, especially when querying a large number of clients, results in increased online interactions, which can affect system performance.

To improve processing efficiency, the inventors, after a series of studies, proposed the technical solutions of this application. In the embodiments of this application, an information carrier that holds a plurality of object names can be acquired, and at least one object name can be recognized from the information carrier. Based on this information carrier, a query operation can be performed to query at least one object that matches each object name. This allows providing the object prompt information for each object corresponding to each object name on the client's display interface. Through the automatic recognition of the information carrier to determine at least one object name, there is no need to manually input object names. When a plurality of object names are recognized, batch object queries can be implemented, improving query efficiency and thus enhancing processing efficiency. This also reduces online interactions, ensuring system performance.

Below, the technical solutions in the embodiments of this application will be clearly and completely described in conjunction with the accompanying drawings in the embodiments of this application. It is evident that the described embodiments are merely a portion of the embodiments of this application, not all of them. All other embodiments that those skilled in the art could derive from the embodiments in this application without making inventive efforts are within the scope of protection of this application.

The technical solutions of this application can be applied to the information processing system shown in FIG. 1. In practical applications, the information processing system can be a CRM system, which may include a client 101 and a server 102.

The client 101 can be a browser, an app (application), a web application such as an H5 (HyperText Markup Language 5) application, a lightweight application (also known as a mini-program, a type of lightweight application), or a cloud application, among others. The client 101 can be deployed on an electronic device, and it may depend on the device's operation or certain apps within the device to function. The electronic device may, for example, have a display screen and support information browsing, such as a personal mobile terminal like a smartphone, tablet, personal computer, or other client terminals. For ease of understanding, FIG. 1 primarily represents the client in the form of a device. Various other types of applications, such as search and instant messaging applications, can also be configured on the electronic device.

The server 102 can be one or more servers providing various services. In other words, it can be implemented as a distributed server cluster consisting of a plurality of servers, or as a single server. Additionally, it can be a server for a distributed system, a server integrated with blockchain technology, a cloud server, or an intelligent cloud computing server or intelligent cloud host with artificial intelligence technology, among others.

In the embodiments of this application, service personnel can interact with the server 102 through the client 101 to receive or send messages, among other actions.

For example, in the embodiments of this application, the server 102 can receive a query request sent from the client 101 based on the information carrier. Based on the at least one object name recognized from the information carrier, the server determines the at least one object that matches the object name. It then sends the object prompt information of the at least one object to the client 101 for display on the client's display interface.

It should be noted that, in the embodiments of this application, the information processing method is generally executed by the server 102, and the corresponding information processing device is generally located on the server 102. The information display method provided in this application is generally executed by the client 101, and the corresponding information display device is generally located on the client 101. However, in other embodiments of this application, the information processing method provided may also be executed jointly by the client 101 and the server 102.

It should be understood that the number of clients and servers in FIG. 1 is merely illustrative. Depending on the implementation requirements, any number of clients and servers may be used.

It should be noted that the embodiments of this application may involve the use of user data. In practical applications, user-specific personal data may be used in the solutions described herein, within the scope permitted by applicable laws and regulations, provided that the requirements of the relevant laws and regulations in the user's country are met (e.g., obtaining explicit user consent, ensuring proper user notification, etc.).

The following will provide a detailed explanation of the technical details of the embodiments of this application.

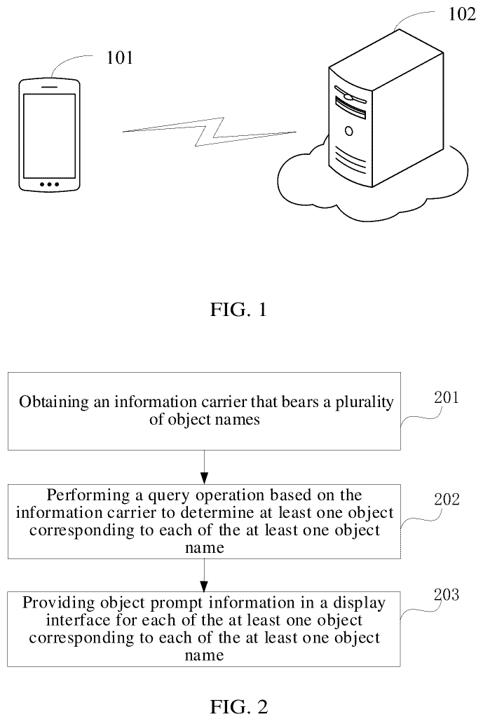

FIG. 2 is a flowchart of an information display method according to an embodiment of the present application. The technical solution of this embodiment can be executed by the client, and the method may include the following steps:

201: obtaining an information carrier that bears a plurality of object names.

An object, for example, can be a client faced by the service personnel. In practical applications, the client may refer to an organization, such as a corporation or other institutions. The object name refers to the client's name, which could be a company name, such as “Shandong XX Smart Equipment Co., Ltd.”

The information carrier that holds a plurality of object names can be, for example, a document or an image. The document could be in formats such as TXT, Word, PowerPoint, Excel, PDF, etc.

The information carrier is used to recognize and obtain therefrom at least one object name.

If the information carrier is a target image containing a plurality of object names, as an optional implementation, acquiring the information carrier that holds a plurality of object names can involve capturing an image of a medium containing a plurality of object names to obtain the target image. For example, image capture can be performed on office building water tags or sign-in registers that contain a plurality of object names.

As another optional implementation, acquiring the information carrier that holds a plurality of object names can involve retrieving the target image from local storage in response to an image selection operation. The target image in local storage may be obtained through image capture by the electronic device configuring the client or downloaded from the network, etc. This application does not limit how the image is obtained.

Alternatively, the target image can also be obtained from a third-party application. The third-party application can initiate a request to the client, thereby transmitting the target image to the client.

If the information carrier is a target image containing a plurality of object names, recognition of the target image can, for example, utilize OCR (Optical Character Recognition) technology to extract text.

If the information carrier is in the form of a document, it can be obtained from local storage, downloaded from the network, or provided by a third-party application. This application does not limit how the document is obtained.

202: performing a query operation based on the information carrier to determine at least one object corresponding to each of the at least one object name.

In this context, executing the query operation based on the information carrier may include: sending a query request to the server based on the information carrier, so that the server can determine at least one object that matches each object name; and receiving the object prompt information of at least one object that matches each object name from the server.

The recognition of the information carrier can be executed by the client or by the server.

Therefore, as an optional implementation, sending a query request to the server based on the information carrier can involve sending a query request that includes the information carrier to the server, so that the server can recognize and obtain at least one object name from the information carrier.

As another optional implementation, sending a query request to the server based on the information carrier can involve performing text recognition on the information carrier and sending a query request that includes the recognition results to the server, so that the server can filter and obtain at least one object name from the recognition results.

The recognition results include one or more candidate names recognized from the information carrier, which the server can filter to obtain at least one object name.

203: providing object prompt information in a display interface for each of the at least one object corresponding to each of the at least one object name.

Each object name can match one or more objects. The matching method can be implemented through text matching, where the object names recognized from the information carrier are compared with the object names stored in the system to determine at least one object that matches each object name. There are various ways to implement text matching, such as matching via keywords, matching based on semantic similarity, or using machine learning models for matching, etc. This application does not limit the specific implementation.

The object prompt information for each object can, for example, include the object name. Additionally, it may also include basic object information such as the object's address and/or contact information.

In this embodiment, the information carrier that holds a plurality of object names is acquired, where the information carrier is used to recognize and obtain at least one object name. Based on this information carrier, a query operation is executed to determine at least one object that matches each object name, and object prompt information for each object is provided on the display interface. The information carrier can be automatically recognized to determine at least one object name, eliminating the need for manual entry of object names. When a plurality of object names are recognized, batch object queries can be executed, improving query efficiency and thus enhancing processing efficiency. This also reduces online interactions, ensuring system performance.

In some embodiments, the method can also provide at least one piece of processing prompt information on the display interface. In response to a processing operation triggered by any piece of processing prompt information, the corresponding target processing method is determined, and at least one target object corresponding to the target processing method is identified. The processing operation is then performed on at least one target object according to the target processing method.

The at least one piece of processing prompt information can correspond to different processing methods, enabling subsequent processing of the objects. For each processing method, at least one target object can be determined. In cases where a plurality of target objects are identified, the technical solutions of this application can not only enable batch querying but also facilitate batch processing. In other words, processing operations can be performed simultaneously on a plurality of target objects, further improving processing efficiency.

Optionally, performing the processing operation on at least one target object according to the target processing method can involve sending a processing request to the server, requesting the server to perform the processing operation on at least one target object according to the target processing method.

In some embodiments, the method can also include: in response to an object selection operation, determining at least one selected candidate object;

the determination of at least one target object corresponding to the target processing method may include: selecting at least one target object from the at least one candidate object based on the target processing method.

In other words, it can involve determining at least one target object corresponding to the target processing method from at least one candidate object selected by the service personnel.

In some embodiments, providing at least one piece of processing prompt information on the display interface may include:
in response to an object selection operation, determining at least one selected target object;
providing at least one piece of processing prompt information for the at least one selected target object on the display interface.

In other words, the service personnel can select the target objects they want to process, and the at least one target object corresponding to the target processing method is determined based on the selection made by the service personnel.

Optionally, at least one object selection control corresponding to each object can be provided on the display interface. The object selection operation can be triggered by selecting different object selection prompts. A selection operation on any object selection prompt will trigger the object selection.

Optionally, at least one object selection control corresponding to each object can be provided on the display interface. The object selection operation can be triggered by selecting different object selection prompts. A selection operation on any object selection prompt will trigger the object selection.

Additionally, based on the different types of processing performed by the service personnel on the objects, a plurality of object states can be defined. These states may include “unfollowed-up,” “followed-up,” and “nonexistent,” among others. At least one processing method includes follow-up, attention, and add methods. For example, an object can only be followed-up by one service personnel. The service personnel can select an object in the “unfollowed-up” state from the system to follow up, thus establishing a first binding relationship between the object and the service personnel. The “unfollowed-up” state indicates that the object has not been followed-up by any service personnel, the “followed-up” state indicates that the object has been followed-up by a service personnel, and the “nonexistent” state means that no information about the object is stored in the system.

The “follow-up” method refers to the establishment of a first binding relationship between the service personnel and an object in the “unfollowed-up” state. The “attention” method refers to the establishment of a second binding relationship between the service personnel and an object in the “followed-up” state. The “add” method refers to saving an object in the “nonexistent” state into the system.

The first binding relationship can be used to determine the objects that the service personnel are following up, while the second binding relationship can determine the objects that the service personnel are paying attention to. If these objects are switched to the “unfollowed-up” state, the service personnel can be promptly notified.

As described above, the processing method can be associated with the object state. For instance, the follow-up method is used for processing objects in the “unfollowed-up” state, the attention method is used for processing objects in the “followed-up” state, and the add method is used for processing objects in the “nonexistent” state. Therefore, the determination of at least one target object corresponding to the target processing method can be based on the association between the processing method and the object state. This allows for identifying at least one target object in the object state that corresponds to the target processing method.

Some embodiments might include processing operations on at least one target object according to a target processing method, where the processing method can be implemented in various ways.

In the case where the target processing method is a “follow-up” method, the process requests that at least one target object, which is in an “unfollowed-up” state, establish a first binding relationship with service personnel and switches the target object to a “followed-up” state.

In the case where the target processing method is a “attention” method, the process requests that at least one target object, which is in a “followed-up” state, establishes a second binding relationship with service personnel. Additionally, if any object with the second binding relationship is in an “unfollowed-up” state, a notification prompt is generated.

In the case where the target processing method is an “add” method, the process requests to determine and save the object-related information of at least one target object that is in a “nonexistent” state, and to switch at least one target object to an “unfollowed-up” state. Through the “add” method, the object can be added to the information processing system, allowing service personnel to perform operations on the object and receive relevant notification information about the object, among other functions.

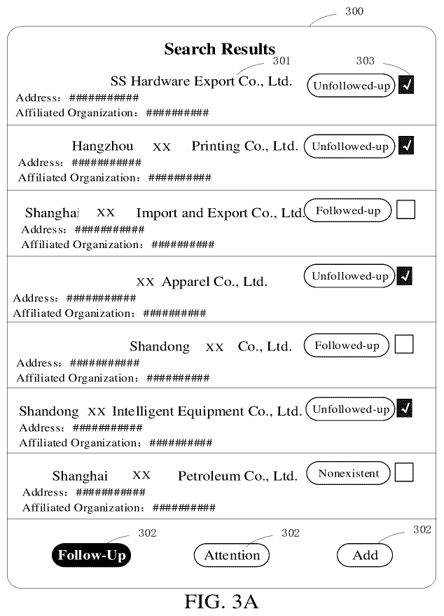

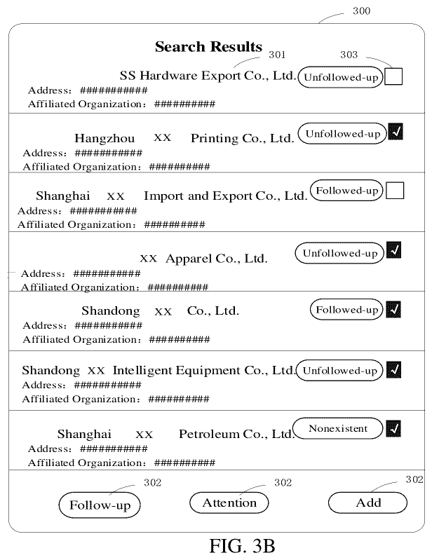

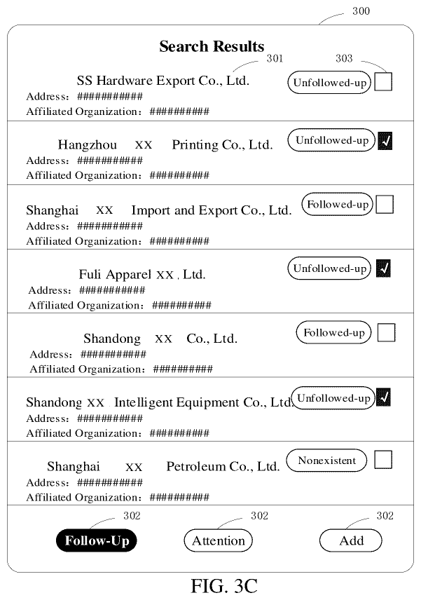

For ease of understanding, FIGS. 3A, 3B, and 3C respectively show schematic diagrams of the display interface. For example, as shown in FIGS. 3A, 3B, and 3C, the display interface 300 can display object prompt information 301 for at least one object, where each object's prompt information may include basic information such as the object's name (e.g., “SS Hardware Export Co., Ltd.”), object address, the organization to which the object belongs, and object status information. The object status information may include states such as “unfollowed-up”, “followed-up”, and “nonexistent”. Additionally, the display interface 300 may also display at least one piece of processing prompt information 302. The processing prompt information can be presented in the form of processing controls, with corresponding processing prompt information displayed within the controls. For example, the processing prompt information may include a follow-up button, an attention button, and an add button, with corresponding target processing methods being the follow-up method, attention method, and add method, respectively.

As shown in FIG. 3A, when the follow-up button is selected, the follow-up button can switch to a display state corresponding to the selected state, such as presenting a specific color (as shown in FIG. 3A) or displaying a specific mark, but this is not limiting in this application. Subsequently, at least one target object in the “unfollowed-up” state can be selected, and optionally, a selected prompt information can be displayed on the display interface. Furthermore, the server can establish a first binding relationship between the selected target object and service personnel. The selected object can then be switched to the “followed-up” state, thereby notifying the service personnel of the operation result, among other things.

Additionally, as shown in FIG. 3B, the display interface 300 can also display an object selection control 303 corresponding to each object. By clicking the object selection control 303, the corresponding candidate object is selected. The object selection control can switch to a display state corresponding to the selected state, such as presenting a specific color as shown in FIG. 3B. Furthermore, by clicking the follow-up button, at least one target object in the “unfollowed-up” state can be selected from the at least one candidate object. Objects in the “followed-up” state and “nonexistent” state among the candidate objects can no longer be selected, as shown in FIG. 3C.

It should be noted that FIGS. 3A to 3C are only for the purpose of illustration, providing example display forms of the display interface for better understanding. This application is not limited to these examples.

Since each object name may match one or more objects, as an optional method, the object prompt information for at least one object corresponding to at least one object name provided on the display interface may include: determining the arrangement order of at least one object corresponding to at least one object name; based on the arrangement order of the at least one object name in the information carrier, determining the display positions corresponding to the at least one object name. Additionally, at the display positions corresponding to the at least one object name, the object prompt information for at least one object can be displayed according to the arrangement order of the corresponding objects.

As another optional method, the object prompt information for at least one object corresponding to at least one object name provided on the display interface may include:
determining the arrangement order of at least one object corresponding to at least one object name; based on the arrangement order, displaying the object prompt information for the first object corresponding to at least one object name on the display interface, along with the view prompt information corresponding to at least one object name.

The method further includes: in response to a triggering operation for the view prompt information corresponding to any object name, displaying the object prompt information for at least one undisplayed object matching the object name according to the corresponding arrangement order.

The first object matching an object name can be the object with the highest sorting priority among the at least one object matching that object name. An undisplayed object refers to any object other than the first object among the objects matching the object name.

The at least one object corresponding to each object name can be implemented using a text-matching method, thereby determining the matching degree between each object name and the at least one object it corresponds to.

Therefore, in some embodiments, determining the arrangement order of at least one object may include: determining the arrangement order of the at least one object based on at least one of the matching degree between the at least one object and the corresponding object name, the object status of the at least one object, and the object ranking of the at least one object.

For example, the matching degree can be determined based on the number of key characters matched in the object name. The more key characters matched, the higher the matching degree and the higher the sorting priority, allowing for the quick identification of objects with higher matching degrees.

The object ranking of at least one object can be determined based on the object status. For example, objects in the “unfollowed-up” state can be assigned a higher sorting priority, enabling the quick identification of objects in the “unfollowed-up” state, thus facilitating timely processing of those objects.

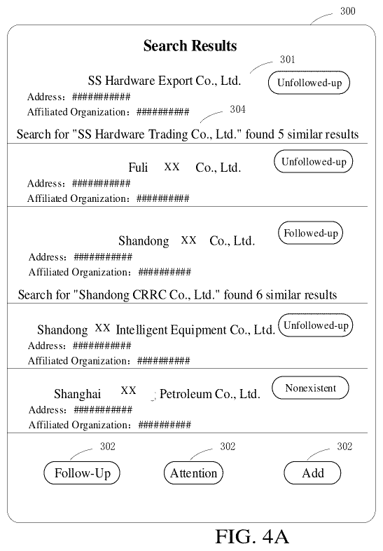

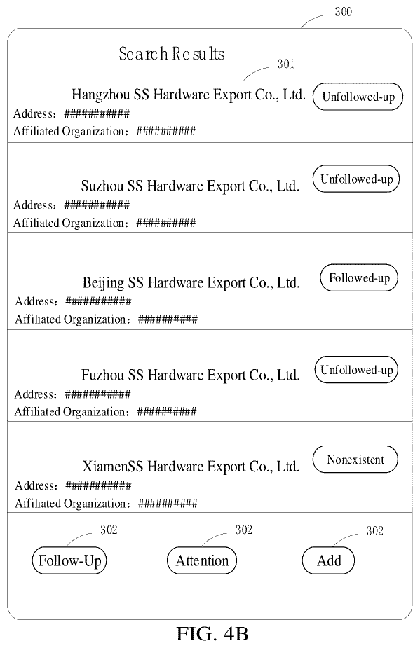

Objects with higher rankings can also be assigned higher sorting priorities. For example, objects with higher information completeness or better credit ratings can be given higher scores, with higher scores corresponding to higher rankings, allowing for the quick identification of trustworthy, high-quality objects. For ease of understanding, as shown in FIGS. 4A and 4B, for instance, the object prompt information for the six objects matching the object name “SS Hardware Trading Co., Ltd.” can be sorted according to sorting priority. In FIG. 4A, the object prompt information 301 for the highest-priority matching object “SS Hardware Export Co., Ltd.” can be displayed first on the display interface 300. By clicking the corresponding view prompt information 304, such as “Search for ‘SS Hardware Trading Co., Ltd.’ and 5 similar results>”, the remaining five matching objects—“Hangzhou SS Hardware Export Co., Ltd.”, “Suzhou SS Hardware Export Co., Ltd.”, “Beijing SS Hardware Export Co., Ltd.”, “Fuzhou SS Hardware Export Co., Ltd.”, and “Xiamen SS Hardware Export Co., Ltd.”—can be displayed in order of arrangement on the display interface 300 as shown in FIG. 4B.

In some embodiments, in order to facilitate understanding of the recognition results, the method may also include:
displaying at least one object name on the display interface.

Additionally, the method may also include:
for at least one object name, displaying at least one operation prompt information;
in response to a triggering operation for any operation prompt information, processing the selected text according to the corresponding operation method.

For example, the operation prompt information may include copy controls, forward controls, translation controls, export controls, etc. By triggering operations on different operation controls, actions such as copying, forwarding, translating, or exporting the selected text can be performed.

Additionally, the method may also include:
for at least one object name, displaying query prompt information;
based on the information carrier, a query operation is performed to determine the at least one object corresponding to each object name. This may include: in response to a query operation triggered by the query prompt information, performing a query operation based on the information carrier to determine the at least one object corresponding to each object name.

In some embodiments, in addition to facilitating batch processing of objects by service personnel, the method may also include: displaying at least one piece of processing prompt information corresponding to the object prompt information for any object on the display interface.

In response to a processing operation triggered by any piece of processing prompt information, determining the corresponding target processing method, and performing the processing operation on the object according to the target processing method.

That is, at least one piece of processing prompt information can be displayed for each object, making it easier for service personnel to perform targeted processing operations on each object.

Optionally, at least one piece of processing prompt information corresponding to the object's status can be displayed based on the object's status.

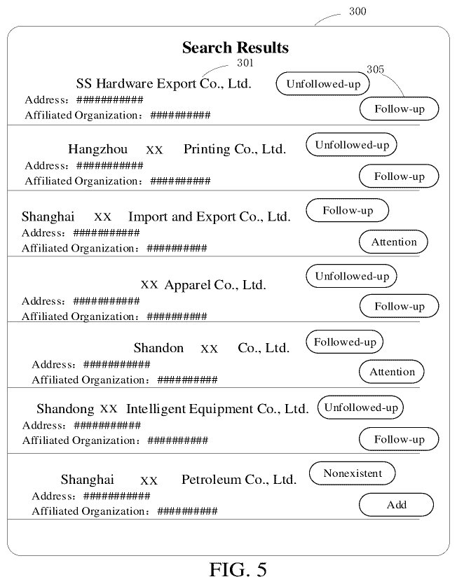

As shown in FIG. 5, for example, in the display interface 300, at least one piece of processing prompt information 305 corresponding to each object can also be displayed. This may include a follow-up button, an attention button, and/or an add button, etc. The object statuses include “unfollowed-up”, “followed-up”, and “nonexistent”, and the corresponding target processing methods are follow-up, attention, and add, respectively. Accordingly, the follow-up button, attention button, and add button are displayed.

Additionally, in order to facilitate service personnel in understanding the object, in some embodiments, the method may also include:
in response to a viewing operation triggered for the object prompt information of any object, displaying the object's detail page on the display interface. The object detail page can display detailed information about the object, such as, in the case where the object is an enterprise, it may include enterprise introduction information such as the enterprise type, industry, and manufacturing information, among others. This application does not limit this.

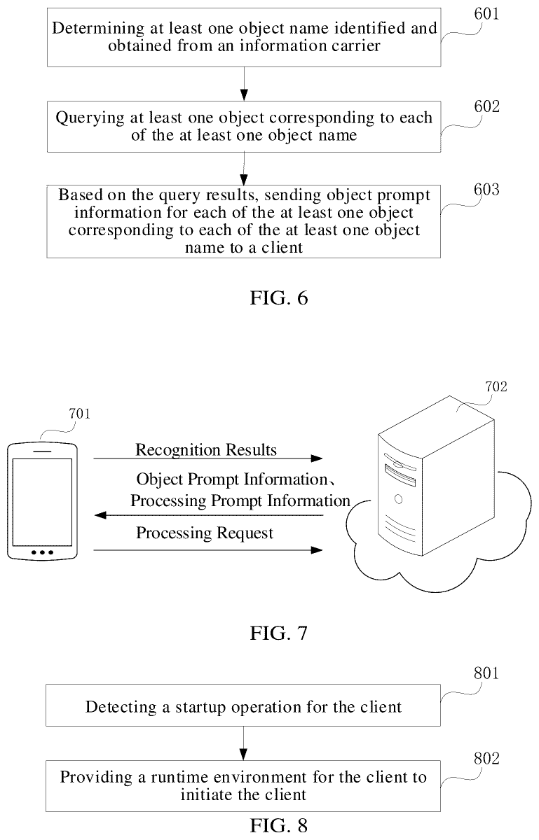

FIG. 6 is a flowchart of an embodiment of an information processing method provided by the present application. The technical solution of this embodiment can be executed by the server, and the method may include the following steps:

601: determining at least one object name identified and obtained from an information carrier.

An object, for example, can be a client that service personnel face. In practical applications, a client can refer to a company or other organizational entities. The object name refers to the client name, which can be the name of a company, such as “Shandong XX Intelligent Equipment Co., Ltd.”, for example.

The information carrier can carry a plurality of object names. The information carrier can be, for example, a document or an image. Documents may include formats such as TXT, Word, PowerPoint, Excel, PDF, and others.

If the information carrier is a target image that carries a plurality of object names, the recognition of the target image can be performed using techniques such as OCR (Optical Character Recognition) to extract the text.

If the information carrier is in document form, it can be obtained from local storage, downloaded from the internet, or provided by a third-party application, etc. This application does not limit such sources.

Additionally, as an optional implementation, determining at least one object name recognized from the information carrier can involve receiving an information carrier sent by the client, performing text recognition on the information carrier, and then filtering the recognition results to obtain at least one object name.

As another optional implementation, it can involve obtaining the recognition results sent by the client and filtering the recognition results to obtain at least one object name. The recognition results are obtained by the client performing text recognition on the information carrier.

The recognition result is the entire text obtained by performing text recognition on the information carrier. The recognition result may include a plurality of recognized texts corresponding to a plurality of object names. Filtering the recognition result to obtain at least one object name includes: filtering out invalid characters from the plurality of recognized texts and filtering out invalid texts from the plurality of recognized texts to obtain at least one object name.

For example, regular expressions or other methods can be used to extract a plurality of recognized texts corresponding to a plurality of object names from the recognition result. Regular expressions or other methods can also be used to filter out invalid characters from the plurality of recognized texts and remove invalid texts from the plurality of recognized texts, thereby obtaining at least one object name.

Invalid characters, for example, may include special characters, emoji, etc. Invalid texts, for example, may include recognized texts that do not conform to the rules. For example, valid texts need to include the terms “limited” or “company,” and recognized texts lacking these terms would be considered invalid.

602: querying at least one object corresponding to each of the at least one object name.

Querying at least one object corresponding to each of the at least one object name may include: for any object name, determining at least one keyword contained in the object name; determining at least one object that matches one or more keywords, thereby matching the object with the object name. The more keywords in the object name that are matched by the object, the higher the matching degree. There are various methods for text matching. Optionally, matching can also be performed by calculating semantic similarity or using machine learning models. This application does not limit these methods.

Additionally, in order to improve query efficiency, querying at least one object corresponding to each object name may include: in cases where at least one object name includes a plurality of names, using a plurality of threads to query at least one object corresponding to each object name in parallel. For example, a plurality of object names can be grouped, with each thread responsible for querying one or more groups of object names, thus improving the efficiency of batch queries.

603: based on the query results, sending object prompt information for each of the at least one object corresponding to each of the at least one object name to a client.

In some embodiments, at least one object name is determined from the information carrier; the information carrier carries a plurality of object names. At least one object corresponding to each object name is queried, and based on the query results, the object prompt information for at least one object corresponding to each object name is sent to the client. Through the implementation of this application, the information carrier can be automatically recognized to determine at least one object name, eliminating the need for manual input of object names. In cases where a plurality of object names are recognized, batch object queries can be performed, improving query efficiency, which in turn enhances processing efficiency. This also reduces online interactive actions and ensures system performance.

In some embodiments, at least one piece of processing prompt information can also be sent to the client. Based on the processing request sent by the client in response to any piece of processing prompt information, the corresponding target processing method is determined, along with at least one target object corresponding to the target processing method. Then, the processing operation is performed on at least one target object according to the target processing method.

The at least one piece of processing prompt information can correspond to different processing methods, enabling subsequent processing of the objects, etc. For each processing method, at least one target object corresponding to the method can be determined. While performing batch queries, batch processing can also be implemented, further improving processing efficiency.

Optionally, the processing operation performed on at least one target object according to the target processing method can be executed according to the target processing method on at least one target object.

In some embodiments, the method may also include: sending object selection prompt information to the client; based on the object selection request sent by the client, determining the at least one selected candidate object;

The determination of at least one target object corresponding to the target processing method may include: determining at least one target object corresponding to the target processing method from the at least one selected candidate object.

That is, at least one target object corresponding to the target processing method can be determined from the at least one follow-up object selected by the service personnel.

In some embodiments, sending at least one piece of processing prompt information to the client may include: based on the object selection request sent by the client, determining the at least one selected target object;
sending at least one piece of processing prompt information for the at least one target object to the client.

That is, the service personnel can select the target objects they wish to process, and the at least one target object corresponding to the target processing method is determined by the service personnel's selection.

Optionally, at least one object selection control corresponding to each object can be sent to the client. The object selection operation can be triggered by different object selection prompt information, and

Of course, as another optional method, selection prompt information can first be sent to the client. The object selection request sent in response to the triggering operation for the selection prompt information can be received. At least one object can be switched to selection mode, and at least one object selection control corresponding to each object can be sent to the client, making it easier for service personnel to perform the object selection operation and select objects from them.

Additionally, based on the different treatments applied by service personnel to the objects, there can be a plurality of object statuses. These statuses may include, for example, “unfollowed-up,” “followed-up,” and “nonexistent.” The at least one processing method includes follow-up, attention, and add methods. For example, an object can only be followed up by one service personnel. The service personnel can select objects in the “unfollowed-up” status from the system for follow-up, thereby establishing a first binding relationship between the object and the service personnel. The “unfollowed-up” status means the object has not been followed up by any service personnel, the “followed-up” status means the object has already been followed up by a service personnel, and the “nonexistent” status means no information about the object is saved in the system.

The follow-up method refers to the service personnel establishing a first binding relationship with an object that is in the “unfollowed-up” status. The attention method refers to the service personnel establishing a second binding relationship with an object that is in the “followed-up” status. The add method refers to saving an object in the “nonexistent” status into the system.

The first binding relationship can be used to determine the objects that the service personnel are following up on, and the second binding relationship can determine the objects that the service personnel are paying attention to. If these objects switch to the “unfollowed-up” status, the service personnel can be notified in a timely manner.

As described above, the processing methods can be associated with object statuses. For example, the follow-up method is used to process objects in the “unfollowed-up” status, the attention method is used to process objects in the “followed-up” status, and the add method is used to process objects in the “nonexistent” status. Therefore, the determination of at least one target object corresponding to the target processing method can be based on the relationship between the processing method and the object status, determining at least one target object that is in the object status corresponding to the target processing method.

Accordingly, in some embodiments, the processing operation performed on at least one target object according to the target processing method may include any of the following implementations:
in the case where the target processing method is the follow-up method, a request is made to establish a first binding relationship between at least one target object in the “unfollowed-up” status and the service personnel, and switch the at least one target object to the “followed-up” status.

In the case where the target processing method is the attention method, a request is made to establish a second binding relationship between at least one target object in the “followed-up” status and the service personnel. If any object with a second binding relationship with a service personnel is in the “unfollowed-up” status, notification prompt information is output. For example, when the target object is switched from the “followed-up” status to the “unfollowed-up” status, the notification prompt information about the status change of the object is only output to the service personnel who have the second binding relationship with the target object. The service personnel can then follow up on the object in a timely manner based on the notification prompt information, and establish a binding relationship with the object.

In the case where the target processing method is the add method, a request is made to determine and save the object-related information for at least one target object in the “nonexistent” status, and switch at least one target object to the “unfollowed-up” status. Through the add method, the object can be added to the information processing system, making it easier for service personnel to perform operations on the object, receive related prompt information about the object, and so on.

In some embodiments, querying at least one object corresponding to each object name may include: querying at least one object corresponding to each object name, and determining the order of at least one object corresponding to each object name.

Additionally, sending the object prompt information for at least one object to the client may include:
determining the display position for at least one object name according to the order of the object names in the information carrier;
sending the display position of at least one object name, the object prompt information for at least one object corresponding to each object name, and the order of at least one object to the client, so that the client can display the object prompt information for at least one object at the corresponding display positions for each object name, in accordance with the respective order of at least one object.

Determining the order of at least one object may include: determining the order of at least one object based on at least one of the matching degree between at least one object and its corresponding object name, the object status of at least one object, and the object ranking of at least one object.

Additionally, in order to improve batch query efficiency, in some embodiments, querying at least one object corresponding to each object name and determining the order of at least one object may include:
in cases where at least one object name includes a plurality of object names, assigning the plurality of object names to a plurality of threads; using a plurality of threads to perform query operations on the assigned object names, to determine at least one object corresponding to each object name and determine the order of at least one object.

In some embodiments, the method may also include:
sending query prompt information to the client;
based on the information carrier, querying at least one object corresponding to each object name in response to the query request sent by the client.

Additionally, to help service personnel understand the objects, in some embodiments, the method may also include:
in response to a viewing request for any object sent by the client, sending the object detail page of that object to the client. In response to the viewing operation for the object prompt information of any object, displaying the object detail page in the display interface. The object detail page may display object details, such as company introduction information, including company type, industry, and production/manufacturing information, if the object is a company. This application does not limit the specific details.

FIG. 7 illustrates a schematic diagram of the scene interaction in a practical application of the technical solution in the embodiments of this application. The service personnel, facing a medium that records a plurality of object names, such as a serial number plate recording a plurality of company names, or a register recording a plurality of company names, can use the client 701 to capture an image of the medium to obtain a target image, which includes the plurality of object names. The client 701 can perform text recognition on the target image and send the recognition result to the server 702.

The target image can also be sent to the server 702, where the server 702 performs the recognition to obtain the recognition result, etc. This application does not limit this.

The server 702 can filter and determine at least one object name from the recognition result, query at least one object corresponding to each object name, and send the object prompt information for at least one object corresponding to each object name to the client 701, so that the client 701 can display the object prompt information for at least one object.

The server 702 may also send at least one piece of processing prompt information to the client 701, determine a corresponding target processing method and determine at least one target object corresponding to the target processing method according to a processing request sent by the client 701 for any piece of the processing prompt information, and perform a processing operation on at least one target object according to the target processing method.

In addition, as can be seen from the preceding description, the client in the embodiment illustrated in FIG. 1 or FIG. 7 may be a lightweight application (also referred to as a mini program, a type of lightweight application), which operates dependent on certain apps, with the app on which it depends being referred to as the main application relative to the lightweight application.

A lightweight application is a type of lightweight application program that can be used without the need for installation and downloading. The development of computer technology has brought new application development models. For instance, providers of large-scale platform application services not only provide their own services to end users based on their platform applications, but also offer developers efficient development frameworks. The functional modules of the platform itself or third-party service applications can all be developed and deployed in a highly efficient manner through the provided development frameworks, and they can be integrated into the main application of the platform with excellent compatibility and stability. Applications developed under this development model not only achieve the aforementioned advantages, but also rely on the brand and user advantages of the application platform to create a mutually beneficial situation for a plurality of parties. For example, on the one hand, the integration of applications enriches the services of the platform, while on the other hand, it saves on the promotion costs of the integrated applications. More importantly, it saves the user's access time and improves the efficiency of application reach. The applications integrated based on this model may be referred to as lightweight applications, or as standalone functional sub-applications, which can operate relying on the main application, that is, using the main application as the runtime container. For example, they can be launched from an interface provided by the main application and allocated a runtime environment by the main application. At the same time, they maintain a certain degree of independence in terms of functionality and runtime characteristics. Lightweight applications typically feature ease of implementation, simple and efficient functionality, and user convenience.

Therefore, as shown in FIG. 8, an information interaction method is further provided in the embodiments of the present application, which is applied to a target application, and the method may include the following steps:

S801: detecting a startup operation for the client.

S802: providing a runtime environment for the client to initiate the client.

Wherein, the client is used to acquire an information carrier bearing a plurality of object names, and based on the information carrier, perform a query operation to determine at least one object that respectively matches each of the at least one object name, and provide, on the display interface, object prompt information of the at least one object respectively matching the at least one object name.

Optionally, the client may specifically perform the information display method described in any of the foregoing embodiments, and the specific operations may be found in the corresponding embodiments described above, which are not repeated here.

In some embodiments, the target application, which serves as the main application of the client, may provide the runtime environment to start the client. In practical applications, the target application may, for example, be an instant messaging (IM) application or the like, so as to integrate the above-mentioned client to provide convenient object query operations, etc., in the context of the widespread use of instant messaging applications today, thereby avoiding the need to download and install the client and improving usability. Of course, the target application in the present application is not limited to instant messaging applications.

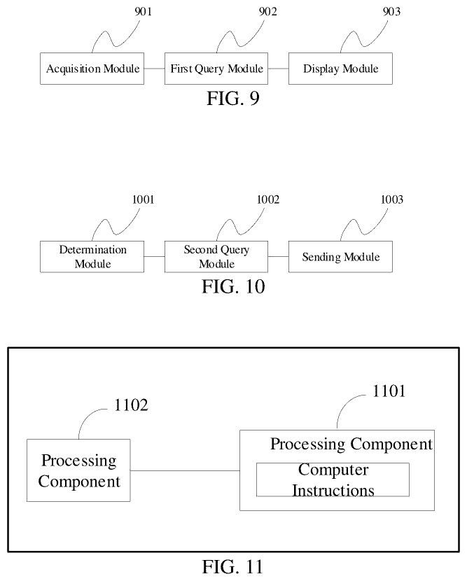

FIG. 9 is a schematic structural diagram of an embodiment of an information display device provided by the present application. The device may include:
an acquisition module 901, configured to acquire an information carrier bearing a plurality of object names;
a first query module 902, configured to perform a query operation based on the information carrier to determine at least one object that respectively matches each of the at least one object name;
a display module 903, configured to provide, on a display interface, object prompt information of the at least one object respectively matching the at least one object name.

The information carrier acquired by the acquisition module is used to identify and obtain at least one object name.

The first query module performs the query operation based on the information carrier, which may include: sending a query request to the server based on the information carrier, so that the server determines at least one object respectively matching each of the at least one object name; and acquiring object prompt information of the at least one object respectively matching each of the at least one object name returned by the server.

The identification of the information carrier may be performed by the client or by the server.

Therefore, as an optional implementation, the query request sent to the server based on the information carrier may be a query request including the information carrier, so that the server can identify and obtain at least one object name from the information carrier.

As another optional implementation, the query request sent to the server based on the information carrier may be a query request including the recognition result, after performing text recognition on the information carrier, so that the server can filter and obtain at least one object name from the recognition result.

In addition, as an optional method, the display module providing object prompt information of at least one object respectively matching at least one object name on the display interface may include: determining the arrangement order of at least one object respectively matching at least one object name; determining the display positions corresponding to each of the at least one object name based on the arrangement order of at least one object name in the information carrier; and at the display positions corresponding to each of the at least one object name, displaying the object prompt information of at least one object in accordance with the respective arrangement order of the at least one object.

As another optional method, the display module providing object prompt information of at least one object respectively matching at least one object name on the display interface may include:
determining the arrangement order of at least one object respectively matching each of the at least one object name; displaying, in accordance with the arrangement order, the object prompt information of the first object respectively matching each of the at least one object name on the display interface, as well as the view prompt information corresponding to each of the at least one object name.

In some embodiments, the display module may further provide at least one piece of processing prompt information on the display interface; in response to a processing operation triggered by any piece of the processing prompt information, determine the corresponding target processing method and determine at least one target object corresponding to the target processing method; and perform a processing operation on the at least one target object according to the target processing method.

The information display device described in FIG. 9 can execute the information display method described in the embodiment shown in FIG. 2, and its implementation principles and technical effects are not repeated here. The specific manner in which each module or unit in the above-described embodiment of the information display device performs operations has already been described in detail in the related embodiments of the method and will not be elaborated upon here.

FIG. 10 is a schematic structural diagram of an embodiment of an information processing device provided by the present application. The device may include:
a determination module 1001, configured to determine at least one object name identified and obtained from the information carrier;
a second query module 1002, configured to query at least one object that respectively matches each of the at least one object name;
a sending module 1003, configured to send, based on the query result, the object prompt information of at least one object respectively matching each of the at least one object name to the client.

The information carrier in the determining module may carry a plurality of object names.

As an optional implementation, the determining module determines that at least one object name obtained from the information carrier through recognition may be an information carrier received from a client and performs text recognition on the information carrier, and then filters to obtain at least one object name from the recognition results.

As another optional implementation, the determining module determines that at least one object name obtained from the information carrier through recognition may be the recognition result received from the client, and filters to obtain at least one object name from the recognition result. The recognition result is obtained by the client performing text recognition on the information carrier.

In some embodiments, the sending module may also send at least one piece of processing prompt information to the client; based on the processing request sent by the client for any piece of processing prompt information, the corresponding target processing method and at least one target object corresponding to the target processing method are determined; and processing operations are performed on at least one target object according to the target processing method.

The at least one piece of processing prompt information may correspond to different processing methods, enabling subsequent processing of objects, etc. For each processing method, at least one corresponding target object can be determined. This allows for batch querying while also enabling batch processing, further improving processing efficiency.

In some embodiments, the second query module queries at least one object that matches at least one object name, which may include: querying at least one object that matches each object name, and determining the arrangement order of at least one object that matches each object name.

In addition, the sending module sending the object prompt information of at least one object to the client may include:
determining the display position corresponding to each at least one object name according to the arrangement order of the at least one object name in the information carrier;
sending the display position of at least one object name, the object prompt information of at least one object matching each object name, and the arrangement order of at least one object to the client, so that the client displays the object prompt information for at least one object at their corresponding display positions, according to the arrangement order of each corresponding at least one object.

In addition, to improve query efficiency, in some embodiments, the query module queries at least one object corresponding to each of the at least one object name, and determines the arrangement order of at least one object, which may include:
when the at least one object name includes a plurality of object names, assigning the plurality of object names to a plurality of threads; using the plurality of threads to perform query operations on the at least one object name assigned to each thread, in order to determine at least one object corresponding to each of the at least one object names, and to determine the arrangement order of the at least one object.

The information processing device shown in FIG. 10 can execute the information processing method described in the embodiment shown in FIG. 6, and its implementation principles and technical effects will not be elaborated further. The specific methods by which each module and unit of the information processing device in the above embodiment performs operations have been described in detail in the relevant embodiment of the method, and will not be further elaborated here.

In addition, the embodiment of the present application also provides an application program, which runs a client to implement the information display method as shown in the embodiment in FIG. 2.

The embodiment of the present application also provides a computing device, as shown in FIG. 11, which may include a storage component 1101 and a processing component 1102;
the storage component 1101 stores one or more computer instructions, where the one or more computer instructions are provided for execution by the processing component 1102 to implement the information display method as shown in the embodiment in FIG. 2, the information processing method as shown in the embodiment in FIG. 6, or the information interaction method as shown in the embodiment in FIG. 8.

Of course, the computing device may also include other components, such as input/output interfaces, communication components, and the like. In the case where the computing device implements the information display method shown in the embodiment in FIG. 2, the computing device may also include a display component, among others.

The input/output interface provides an interface between the processing component and the peripheral interface module, where the peripheral interface module can be an output device, an input device, and so on. The communication component is configured to facilitate wired or wireless communication between the computing device and other devices.

The processing component 1102 may include one or more processors to execute computer instructions to complete all or part of the steps in the method described above. Of course, the processing component may also be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the above methods.

The storage component 1101 is configured to store various types of data to support the operation of the terminal. The storage component can be implemented using any type of volatile or non-volatile storage device, or a combination thereof, such as static random-access memory (SRAM), electrically erasable programmable read-only memory (EEPROM), erasable programmable read-only memory (EPROM), programmable read-only memory (PROM), read-only memory (ROM), magnetic storage, flash memory, magnetic disks, or optical disks.

The display component may be an electroluminescent (EL) element, a liquid crystal display (LCD), or a miniature display with a similar structure, or a retina-direct display or a similar laser-scanning display.

It should be noted that, in the case where the computing device implements the information display method shown in the embodiment in FIG. 2 or the information interaction method shown in the embodiment in FIG. 8, it can specifically be implemented as an electronic device. An electronic device refers to a device used by the user that has functions such as computing, internet access, communication, and the like. For example, it can be a mobile phone, tablet computer, personal computer, wearable device, etc.

In the case where the computing device implements the information interaction method shown in the embodiment in FIG. 8, it can specifically be implemented as an electronic device. Therefore, as another embodiment, the present application also provides an electronic device, which may include a display component, a processing component, and a storage component; the storage component stores one or more computer instructions; the one or more computer instructions are called and executed by the processing component to run the target application, and in the target application, the client is run to implement the information display method shown in the embodiment in FIG. 2.

In addition, in the case where the computing device implements the information processing method shown in the embodiment in FIG. 6, it can be a physical device or an elastic computing host provided by a cloud computing platform. It can be implemented as a distributed cluster composed of a plurality of servers or terminal devices, or it can be implemented as a single server or a single terminal device.

The embodiment of the present application also provides a computer-readable storage medium, storing a computer program, which, when executed by a computer, can implement the information display method shown in the embodiment in FIG. 2, the information processing method shown in the embodiment in FIG. 6, or the information interaction method shown in the embodiment in FIG. 8. The computer-readable medium can be included in the electronic device described in the above embodiments; it can also exist independently and not be incorporated into the electronic device.

The embodiment of the present application also provides a computer program product, which includes a computer program stored on a computer-readable storage medium, the computer program, when executed by a computer, being capable of implementing the information display method shown in the embodiment in FIG. 2 or the information processing method shown in the embodiment in FIG. 6.

In such an embodiment, the computer program may be downloaded and installed from a network, and/or installed from a removable medium. When executed by a processor, the computer program performs the various functions defined in the system of the present application.

The computer-readable storage medium in the corresponding embodiments mentioned above can be, for example, but is not limited to, electrical, magnetic, optical, electromagnetic, infrared, or semiconductor systems, devices, or components, or any combination thereof. More specific examples of computer-readable storage media may include, but are not limited to: electrical connections with one or more conductors, portable computer disks, hard drives, random access memory (RAM), read-only memory (ROM), erasable programmable read-only memory (EPROM), flash memory, optical fibers, portable compact disc read-only memory (CD-ROM), optical storage devices, magnetic storage devices, or any suitable combination of the above. In the present application, the computer-readable storage medium can be any tangible medium that contains or stores a program, which can be used or combined with an instruction execution system, device, or apparatus.

It will be apparent to those skilled in the art that, for the sake of convenience and brevity in description, the specific operations of the systems, devices, and units described above can be referenced to the corresponding processes in the previously described method embodiments, and will not be reiterated here.

The device embodiments described above are merely illustrative. The units described as separate components may or may not be physically separated, and the components displayed as units may or may not be physical units, meaning they can either be located in a single place or distributed across a plurality of network units. Some or all of the modules can be selected based on actual needs to achieve the objectives of the present embodiment. One skilled in the art can understand and implement the solution without creative effort.

From the description of the above embodiments, those skilled in the art will clearly understand that each embodiment can be implemented using software along with the necessary general-purpose hardware platform, or alternatively, it can be implemented through hardware. Based on this understanding, the technical solution described above, or more specifically, the part that contributes to the existing technology, can be embodied as a software product. This computer software product can be stored on a computer-readable storage medium, such as ROM/RAM, magnetic disks, optical discs, etc., and includes several instructions to cause a computing device (which can be a personal computer, server, or network device, etc.) to perform the methods described in the various embodiments or certain parts of the embodiments.

Finally, it should be noted that the above embodiments are only used to illustrate the technical solutions of this application, and are not intended to limit them; although this application has been described in detail with reference to the foregoing embodiments, those skilled in the art should understand that: modifications can still be made to the technical solutions recorded in the foregoing embodiments, or equivalent substitutions can be made for some of the technical features therein; and these modifications or substitutions do not cause the essence of the corresponding technical solutions to depart from the spirit and scope of the technical solutions of the embodiments of this application.

What is claimed is:

1. An information display method, comprising:
obtaining an information carrier that bears a plurality of object names, the information carrier being used to identify and obtain at least one object name therefrom;
performing a query operation based on the information carrier to determine at least one object corresponding to each of the at least one object name;
providing object prompt information in a display interface for each of the at least one object corresponding to each of the at least one object name.

2. The method according to claim 1, further comprising:
providing at least one piece of processing prompt information in the display interface;
in response to a processing operation triggered for any piece of the processing prompt information, determining a corresponding target processing method and determining at least one target object corresponding to the target processing method;
performing a processing operation on the at least one target object according to the target processing method.

3. The method according to claim 2, wherein performing the processing operation on the at least one target object according to the target processing method comprises one of the following:
when the target processing method is a follow-up method, requesting to establish a first binding relationship between the at least one target object in an unfollowed-up state and a service personnel, and switching the at least one target object to a followed-up state;
when the target processing method is an attention method, requesting to establish a second binding relationship between the at least one target object in a followed-up state and a service personnel, and outputting notification prompt information when an object with a second binding relationship with the service personnel is in an unfollowed-up state;
when the target processing method is an add method, requesting to determine and store object-related information for the at least one target object in a nonexistent state, and switching the at least one target object to an unfollowed-up state.

4. The method according to claim 1, wherein the information carrier is a target image bearing a plurality of object names, and the obtaining of the information carrier bearing the plurality of object names comprises:
performing image acquisition on a medium containing a plurality of object names to obtain the target image; or
in response to an image selection operation, obtaining the target image from a local storage.

5. The method according to claim 1, wherein performing a query operation based on the information carrier to determine at least one object corresponding to each of the at least one object name comprises:
sending a query request including the information carrier to a server, so that the server identifies and obtains at least one object name from the information carrier; or
performing text recognition on the information carrier, and sending a query request including the recognition results to the server, so that the server filters and obtains at least one object name from the recognition results.

6. The method according to claim 1, wherein providing object prompt information for each of the at least one object corresponding to each of the at least one object name in the display interface comprises:
determining an arrangement order of the at least one object corresponding to each of the at least one object name; and, based on the arrangement order of the at least one object name in the information carrier, determining display positions corresponding to each of the at least one object name, and displaying the object prompt information for the at least one object at their corresponding display positions according to the arrangement order of each corresponding at least one object;
or, determining the arrangement order of the at least one object corresponding to each of the at least one object name; and, based on the arrangement order, displaying the object prompt information for a first object corresponding to each of the at least one object name in the display interface, as well as displaying view prompt information corresponding to each of the at least one object name, wherein the method further comprises in response to a triggering operation for the view prompt information corresponding to any of the object names, displaying the object prompt information for at least one undisplayed object corresponding to the object name, according to the corresponding arrangement order.

7. A non-transitory computer-readable storage medium configured with instructions executable by one or more processors to cause the one or more processors to perform the method of claim 1.

8. An electronic device comprising:
one or more processors; and
one or more computer-readable memories coupled to the one or more processors and having instructions stored thereon that are executable by the one or more processors to perform the method of claim 1.

9. An information processing method, comprising:
determining at least one object name identified and obtained from an information carrier, the information carrier bearing a plurality of object names;
querying at least one object corresponding to each of the at least one object name;
based on the query results, sending object prompt information for each of the at least one object corresponding to each of the at least one object name to a client.

10. The method according to claim 9, further comprising:
sending at least one piece of processing prompt information to the client;
determining a corresponding target processing method and determining at least one target object corresponding to the target processing method in response to a processing request sent by the client for any piece of the processing prompt information;
performing a processing operation on the at least one target object according to the target processing method.

11. The method according to claim 10, wherein performing the processing operation on the at least one target object according to the target processing method comprises any of the following implementations:
when the target processing method is a follow-up method, establishing a first binding relationship between the at least one target object in an unfollowed-up state and a service personnel, and switching the at least one target object to a followed-up state;
when the target processing method is an attention method, establishing a second binding relationship between the at least one target object in a followed-up state and a service personnel, and notifying the service personnel when an object with a second binding relationship to the service personnel is in an unfollowed-up state;
when the target processing method is an add method, storing object-related information for the at least one target object in a nonexistent state, and switching the at least one target object to an unfollowed-up state.

12. The method according to claim 9, wherein querying at least one object corresponding to each of the at least one object name comprises:
querying at least one object corresponding to each of the at least one object name, and determining the arrangement order of at least one object corresponding to each of the at least one object name;
and wherein sending the object prompt information for the at least one object to the client comprises:
determining display positions corresponding to each of the at least one object name based on the arrangement order of the at least one object name in the information carrier;
sending the display positions of the at least one object name, the object prompt information for each of the at least one object corresponding to each of the at least one object name, and the arrangement order of the at least one object to the client, so that the client displays the object prompt information for each of the at least one object at their corresponding display positions according to the arrangement order of each corresponding at least one object.

13. The method according to claim 12, wherein querying at least one object corresponding to each of the at least one object name and determining the arrangement order of the at least one object comprises:
when the at least one object name comprises a plurality of object names, assigning the plurality of object names to a plurality of threads;
using the plurality of threads to perform query operations on the at least one object name assigned to each thread, in order to determine at least one object corresponding to each of the at least one object names and to determine the arrangement order of the at least one object.

14. A non-transitory computer-readable storage medium configured with instructions executable by one or more processors to cause the one or more processors to perform the method of claim 9.

15. An electronic device comprising:
one or more processors; and
one or more computer-readable memories coupled to the one or more processors and having instructions stored thereon that are executable by the one or more processors to perform the method of claim 9.

16. An information interaction method, comprising:
detecting a startup operation on the client;
providing a runtime environment on the client to initiate the client, the client being configured to obtain an information carrier bearing a plurality of object names, and based on the information carrier, perform a query operation to determine at least one object corresponding to each of at least one object names, provide object prompt information for each of the at least one object corresponding to each of the at least one object names in a display interface.

17. The method according to claim 16, wherein the client is further configured to:
provide at least one piece of processing prompt information in the display interface;
in response to a processing operation triggered for any piece of the processing prompt information, determine a corresponding target processing method and determining at least one target object corresponding to the target processing method;
perform a processing operation on the at least one target object according to the target processing method.

18. The method according to claim 17, wherein to perform the processing operation on the at least one target object according to the target processing method, the client is configured to:
when the target processing method is a follow-up method, request to establish a first binding relationship between the at least one target object in an unfollowed-up state and a service personnel, and switching the at least one target object to a followed-up state;
when the target processing method is an attention method, request to establish a second binding relationship between the at least one target object in a followed-up state and a service personnel, and outputting notification prompt information when any object with a second binding relationship with the service personnel is in an unfollowed-up state; or
when the target processing method is an add method, request to determine and store object-related information for the at least one target object in a nonexistent state, and switching the at least one target object to an unfollowed-up state.

19. The method according to claim 16, wherein the information carrier is a target image bearing a plurality of object names, and to obtain of the information carrier bearing the plurality of object names, the client is configured to:
perform image acquisition on a medium containing a plurality of object names to obtain the target image; or
in response to an image selection operation, obtain the target image from a local storage.

20. The method according to claim 16, wherein to perform a query operation based on the information carrier to determine at least one object corresponding to each of the at least one object name, the client is configured to:
send a query request including the information carrier to a server, so that the server identifies and obtains at least one object name from the information carrier; or
perform text recognition on the information carrier, and sending a query request including the recognition results to the server, so that the server filters and obtains at least one object name from the recognition results.
